(19) United States
(12) Patent Application Publication
(10) Pub. No.: US 2006/0203342 A1
(43) Pub. Date: Sep. 14, 2006

(54) Changeable mirror surface

(76) Inventor: Chin-Yuan Chen, Wuri Shiang (TW)

Correspondence Address: CHARLES E. BAXLEY, ESQ., 90 JOHN STREET, THIRD FLOOR, NEW YORK, NY, 10038, US

(21) Appl. No.: 11/075,575

(22) Filed: Mar. 9, 2005

(51) Int. Cl. G02B 1/00

(52) U.S. Cl. 359/507; 359/509

(57) ABSTRACT

The present invention relates to a changeable mirror surface that comprises anti-fog area and non-anti-fog area, wherein the anti-fog area will cooperate with the non-anti-fog area to form a predetermined pattern when condensation of water forms on the mirror surface.

### BACKGROUND OF THE INVENTION

1. Field of the Invention

The present invention relates to a mirror, and more particularly to a changeable mirror surface.

2. Description of the Prior Arts

Mirror is an indispensable article in daily life, whatever changes could be made to the profile of the mirror or to the mirror-frame, however, the mirror surface is always unchangeable and merely includes anti-fog mirror surface and non-anti-fog mirror surface, and both the anti-fog mirror surface and the non-anti-fog mirror surface are impossible to be formed with a condensation-caused pattern under high humidity or rapid temperature changes.

The present invention has arisen to mitigate and/or obviate the afore-described disadvantages.

### SUMMARY OF THE INVENTION

The primary objective of the present invention is to provide a changeable mirror surface which can be formed with a condensation-caused pattern under high humidity or rapid temperature changes.

a changeable mirror surface provided in accordance with the present invention comprises anti-fog area and non-anti-fog area, wherein the anti-fog area will cooperate with the non-anti-fog area to form a predetermined pattern when condensation of water forms on the mirror surface.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a plan view of a changeable mirror surface in accordance with a first preferred embodiment of the present invention;

FIG. 2 is a side view a changeable mirror surface in accordance with the first preferred embodiment of the present invention;

FIG. 3 shows a changeable mirror surface in accordance with the first preferred embodiment of the present invention, on which appear the letters;

FIG. 4 is a plan view of a changeable mirror surface in accordance with a second preferred embodiment of the present invention;

FIG. 5 is a side view a changeable mirror surface in accordance with the second preferred embodiment of the present invention;

FIG. 6 shows a changeable mirror surface in accordance with the second preferred embodiment of the present invention, on which appear the letters;

### DETAILED DESCRIPTION OF THE PREFERRED EMBODIMENTS

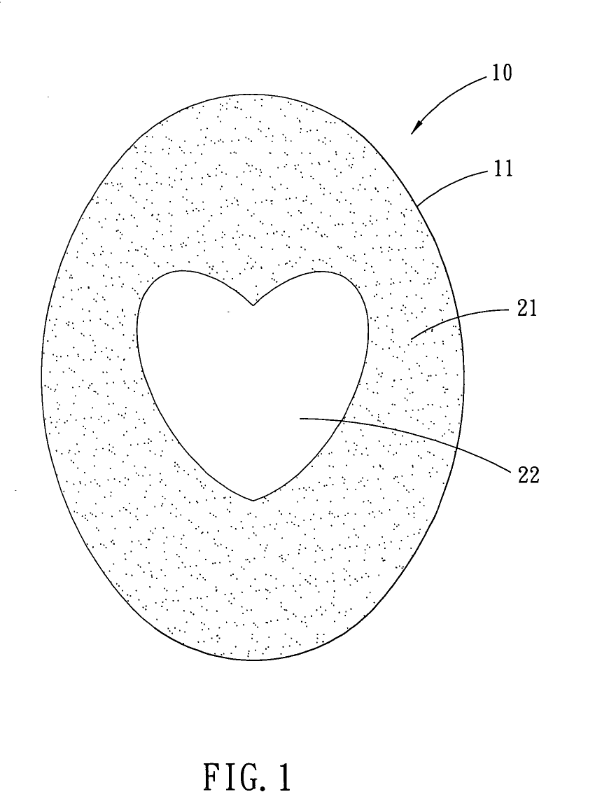

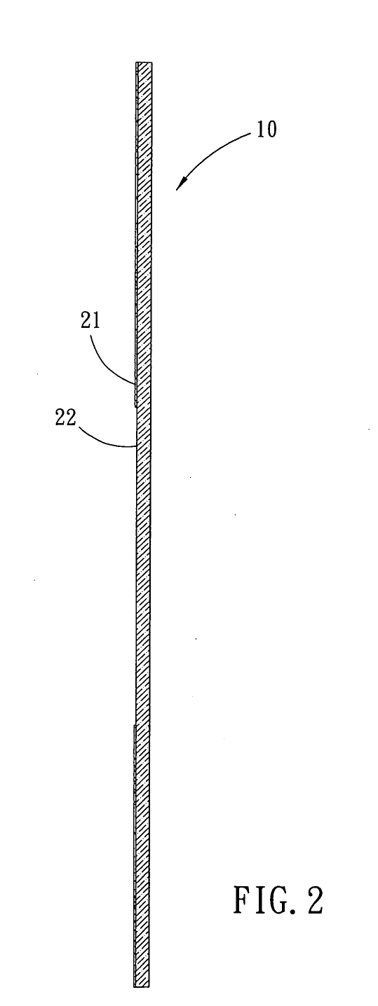

Referring to FIGS. 1 and 2, a changeable mirror surface 11 of a mirror 10 in accordance with a first embodiment of the present invention is shown and includes a non-anti-fog area 21 and an anti-fog area 22. The anti-fog area 22 is coated with anti-fog material and formed in a predetermined pattern, a heart pattern, for example, while the non-anti-fog area 21 is the profile of the predetermined pattern.

Therefore, condensation or fog will form on the non-anti-fog area 21 of the mirror surface 11, whereas the anti-fog area 22 will be free of condensation, when the mirror 10 is subjected to high humidity or rapid temperature changes. At this moment, a heart-shaped pattern without condensation will be formed on the mirror surface 11 of the mirror 10 since the anti-fog area 22 is heart-shaped and the non-anti-fog area 21 is formed in correspondingly to the profile of the heart pattern.

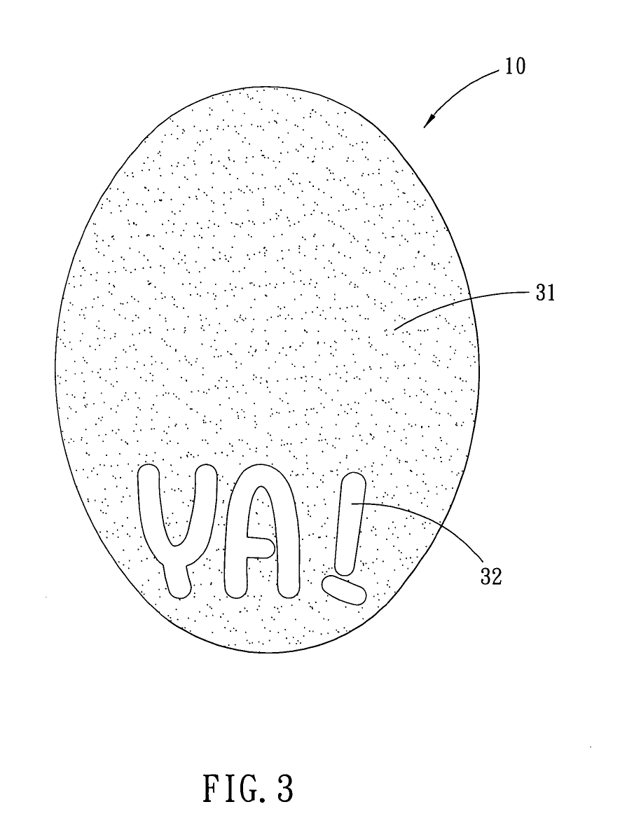

Referring to further to FIG. 3, besides patterns, the predetermined pattern formed by the non-anti-fog area 31 and the anti-fog area 32 also can be letters.

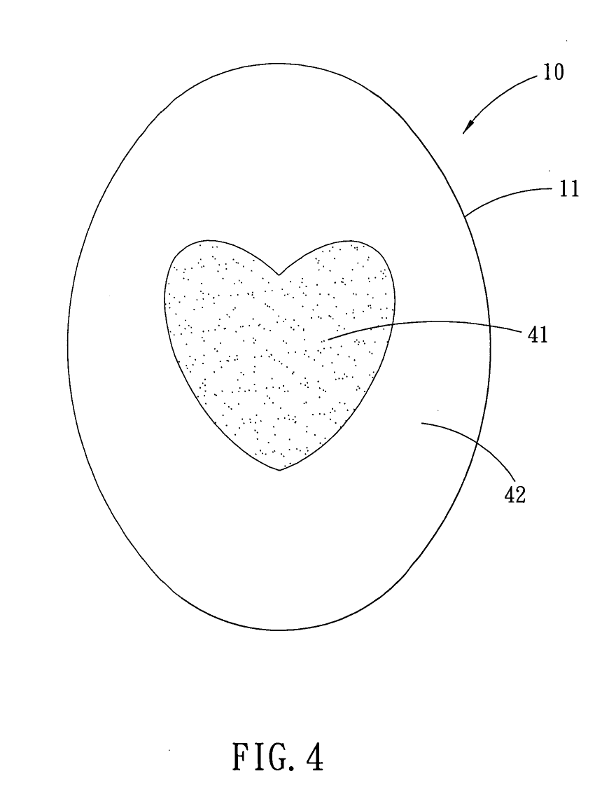

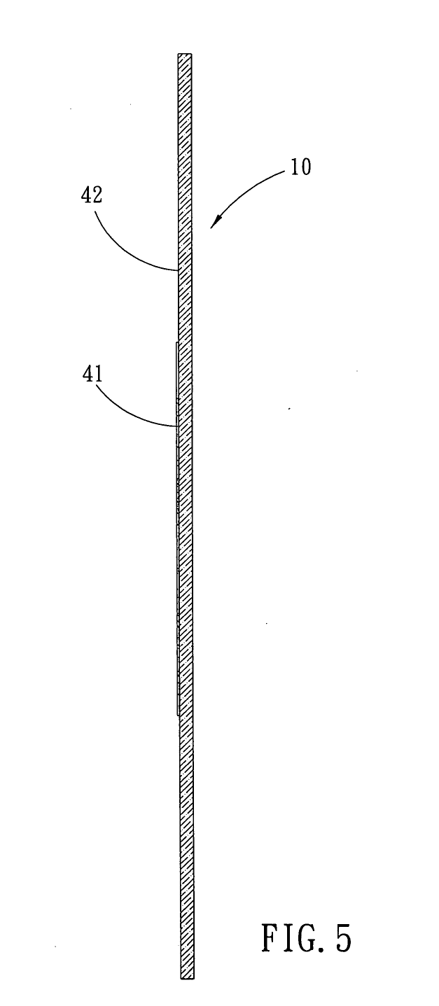

Referring next to FIG. 4 and 5, a changeable mirror surface 11 of a mirror 10 in accordance with a second embodiment of the present invention also includes a non-anti-fog area 41 and an anti-fog area 42. The anti-fog area 42 is coated with anti-fog material, this embodiment is similar to the first embodiment, except that the following aspects:

The anti-fog area 42 is formed correspondingly to the profile of a predetermined pattern (a heart pattern), in other words, the heart is formed by drops of water condensed on the non-anti-fog area 41, when the mirror 10 is subjected to high humidity or rapid temperature changes.

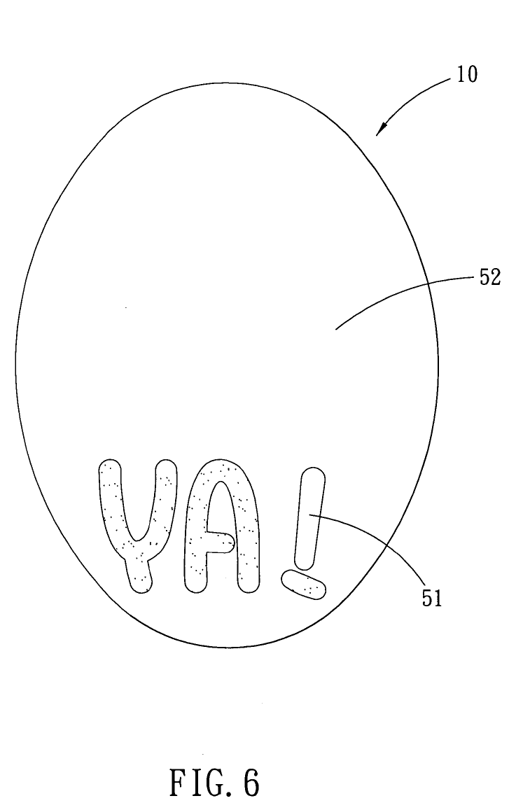

Referring finally to FIG. 6, besides patterns, the predetermined pattern formed by the non-anti-fog area 51 and the anti-fog area 52 also can be letters.

While we have shown and described various embodiments in accordance with the present invention, it should be clear to those skilled in the art that further embodiments may be made without departing from the scope of the present invention.

What is claimed is:

1. A changeable mirror surface comprising anti-fog area and non-anti-fog area, wherein the anti-fog area will cooperate with the non-anti-fog area to form a predetermined pattern when condensation of water forms on the mirror surface.

2. The changeable mirror surface as claimed in claim 1, wherein the anti-fog area of the mirror surface is coated with anti-fog material.

3. The changeable mirror surface as claimed in claim 1, wherein the non-anti-fog area is formed correspondingly to profile of a predetermined pattern.

4. The changeable mirror surface as claimed in claim 1, wherein the anti-fog area is formed correspondingly to profile of a predetermined pattern.

5. The changeable mirror surface as claimed in claim 1, wherein the predetermined pattern formed by the non-anti-fog area and the anti-fog area is a shape.

6. The changeable mirror surface as claimed in claim 1, wherein the predetermined pattern formed by the non-anti-fog area and the anti-fog area is a letter.
